(19) United States
(12) Patent Application Publication
(10) Pub. No.: US 2025/0314619 A1
(43) Pub. Date: Oct. 9, 2025

(54) DUAL-MODE SENSOR AND ARRAY FOR EDDY CURRENT TESTING AND CAPACITIVE IMAGING

(71) Applicants: BOARD OF TRUSTEES OF MICHIGAN STATE UNIVERSITY, East Lansing, MI (US); Government of the United States, as represented by the Secretary of the Army, Warren, MI (US)

(72) Inventors: Oleksii Karpenko, Lansing, MI (US); Eric Tarkleson, Lansing, MI (US); Lalita Udpa, Okemos, MI (US); Satish Udpa, Okemos, MI (US); Mahmoodul Haq, Okemos, MI (US); David Gorsich, Shelby Township, MI (US)

(21) Appl. No.: 19/170,808

(22) Filed: Apr. 4, 2025

Related U.S. Application Data
(60) Provisional application No. 63/574,968, filed on Apr. 5, 2024.

(51) Int. Cl. G01N 27/904; G01N 27/90

(52) U.S. Cl. CPC G01N 27/904; G01N 27/9006

(57) ABSTRACT

The disclosure relates to a dual-mode sensor and sensor array for eddy current testing and capacitive imaging, for example for use in non-destructive evaluation of a specimen to detect potential internal defects within the specimen. The sensor includes first and second concentrically aligned electrical coils coupled to an AC power source and an amplifier. The concentric electrical coils allow the dual-mode sensor to operate in an eddy current testing (ECT) mode or a capacitive imaging (CI) mode. In the ECT mode, the first electrical coil and the second electrical coil are electrically connected to the AC power source to provide magnetic field excitation and magnetic field pickup in the first and second electrical coils. In the CI mode, the first and second electrical coils are electrically connected to the AC power source such that the first and second electrical coils are charged electrodes in a disk-and-ring capacitor configuration.

### CROSS REFERENCE TO RELATED APPLICATION

Priority is claimed to U.S. Provisional Application No. 63/574,968 (filed Apr. 5, 2024), which is incorporated herein by reference in its entirety.

### STATEMENT OF GOVERNMENT INTEREST

None.

### BACKGROUND OF THE DISCLOSURE

### Field of the Disclosure

The disclosure relates to a dual-mode sensor and sensor array for eddy current testing and capacitive imaging, for example for use in non-destructive evaluation of a specimen to detect potential internal defects within the specimen. The sensor includes first and second concentrically aligned electrical coils in electrical connection with an AC power source and an amplifier, and the electrical coils are capable of induction when electrical current flows between the inner and outer nodes of a given coil. The concentric structure of the electrical coils allows the dual-mode sensor to operate in either an eddy current testing (ECT) mode or a capacitive imaging (CI) mode.

### Background

Fiber reinforced plastics (FRPs) have proven to be a superior design choice for modern fuel and/or energy efficient vehicles, systems and structures due to the multitude of benefits they offer, such as light weight, high specific strength, high specific stiffness, and long-lasting environmental stability. Flexibility to strategically tailor mechanical properties for target applications combined with the capabilities of rapid, cost-effective production and eco-friendly recycling have propelled the wide acceptance of carbon, glass and aramid FRP in aerospace, automotive, marine, defense, energy, construction, and sporting industries. However, FRPs are known to be vulnerable to flaws during fabrication and operation, which could lead to unforeseen failures of FRP structural components. Nondestructive evaluation (NDE) of FRP is essential, but challenging owing to the presence of interlaminar interfaces and anisotropy of material properties, which result in complex mechanisms of damage onset and propagation.

A number of electromagnetic (EM) techniques have been developed for NDE of FRP composites, including static, low frequency (quasi-static) and high frequency techniques. The main appeal of EM NDE is non-contact inspection with no couplants.

High frequency EM methods such as near field or far field microwave imaging and terahertz ray imaging have shown promise for the detection of volumetric defects in glass FRP and other dielectric composites. One drawback of the aforementioned technologies is that the penetration depth of the fields at GHz and THz frequencies is limited for electrically conductive test materials such as carbon FRP. Other high frequency EM NDE methods use ionizing radiation, which typically requires implementation of safety measures for inspectors. For example, X-ray computerized tomography (CT) of small CFRP samples is performed in shielded chambers. Portable X-ray imaging systems use low intensity radiation sources and matrix photon counting photodetectors. X-ray techniques provide good sensitivity to various types of flaws in FRP except for interlaminar delaminations, which are common and critical. Generally, high frequency NDE techniques require sophisticated and costly equipment for wave excitation and sensing.

The focus is on the low frequency (KHz and MHZ) EM techniques for NDE of FRP.

One of the well-established low frequency EM methods is eddy current testing (ECT). Various ECT systems have heretofore been provided for the detection of fiber damage and fiber irregularities in electrically conductive CFRP laminates. Typical ECT systems include field producing means such as an excitation coil connected to an AC generator to induce eddy currents in a CFRP test specimen, and a sensing means to pick up the field produced by the eddy currents. The sensing means may be implemented as separate receiving coils, magnetoresistive sensors or other magnetic field detectors. The excitation coil may also be used to sense the induced field, by measuring the effective impedance thereof. Single-sensor eddy current probes are easily scalable to array probes, which provide sufficient spatial coverage and resolution to inspect wider sections of CFRP test parts in one pass. Coils in commercial ECT arrays are usually machine wound using a small gauge wire and are later embedded into a flexible substrate in order to let the probe conform to the curvature of the test sample. Pancake coils can also be fabricated directly as parts of a multi-layered printed circuit board (PCB). Despite good sensitivity of ECT probes to defects associated with fiber breakage and fiber irregularities in CFRP, problems remain. A common issue is the detection of interlaminar delaminations in classical CFRP laminates and multi-layered CFRP laminates with in-plane weave. The reason behind this is low electrical conductivity in the transverse direction compared to the electrical conductivity along the principal directions of carbon fibers. Hence, there is a need for a synergistic NDE technique such as capacitive sensing that would furnish information about the imperfections of a polymer epoxy matrix.

Low frequency NDE modalities that utilize capacitive measurements for characterization of FRP generally fall under the category of dielectrometry. Capacitive probes generate a time-varying electric field in FRP, and the presence of defects, such as air voids, interlaminar delaminations and/or irregular fiber distribution, leads to local changes of dielectric properties, resulting in variations in measured capacitance. Practical setups for capacitive imaging (CI) of FRP utilize sensors with coplanar electrodes such that the test specimen could be accessed from only one side. Depending on the geometry of the electrodes, capacitive probes can be broadly classified as triangular, rectangular (open plates), annular (disk-and-ring), or interdigital with each type having its distinct advantages and limitations. Capacitive imaging is suited for NDE of dielectric composites, such as glass and aramid FRP. Penetration depth of the electric field into CFRP composites is lower compared to that into GFRP. Nonetheless, capacitive imaging of CFRP is feasible owing to the fact that the cross-ply electric conductivity, and hence the attenuation of the electric field, are weak in the transverse direction.

Dual-mode or hybrid EM probes combine ECT and CI for NDE of FRP composites. The simplest hybrid probe can be realized as a single pancake coil fabricated on a PCB. If driven below self-resonance, the coil serves as an eddy current sensor. Conversely, when the excitation frequency is above self-resonance, the coil exhibits the characteristics of a capacitive sensor. However, a possible issue with such an approach is that the development of an array probe requires minimization of the coil diameter, which in turn increases the resonant frequency. Therefore, CI above coil self-resonance may increase the complexity and cost of data acquisition equipment or may render the probe incompatible with commercially available multi-channel NDE systems for ECT.

An alternative way to build a dual-mode probe is to embed separate coplanar coils and capacitors in different cross-sections of an FPCB. Stacking coil and capacitive sensors on top of each other can be easily achieved by modern PCB production processes. However, it is advantageous to use multiple layers of coil windings in order to increase the number of turns and sensitivity to flaws. If the latter is done, the capacitive layer will have a higher lift-off with respect to the sample's surface, hence the signal generated by the capacitive sensors will be reduced.

Dual-mode sensing can also be accomplished by multiplexing the terminals of coplanar coils printed on a PCB. For example, regular ECT was performed in by driving a pair of adjacent square coils in the absolute mode, and an open plate capacitive sensor for CI was implemented using the same two coils. In CI mode, one terminal of each coil was disconnected, and remining terminals were used for applying different electric potentials to coil windings, which formed capacitor electrodes. However, the electric field produced by the open plate capacitor didn't have rotational symmetry.

### SUMMARY

Despite recent advances in dual-mode (ECT and CI) probe development, there are unsolved challenges. What is needed is a compact sensor array supporting dual-mode operation and associated methods and systems which can be used in applications, such as, but not limited to quantitative NDE of multi-layered FRP materials and structures.

In one aspect, the disclosure relates to a dual-mode sensor (or sensor array) for eddy current testing and capacitive imaging, the sensor comprising: a first electrical coil defining (or having) (i) an inner node (or terminal/point of electrical contact) at a radial position R_{i,1} and (ii) an outer node (or terminal/point of electrical contact) at a radial position R_{o,1}, wherein R_{i,1}<R_{o,1}; a second electrical coil around and concentric with the first electric coil, the second electrical coil defining (or having) (i) an inner node (or terminal/point of electrical contact) at a radial position R_{i,2} and (ii) an outer node (or terminal/point of electrical contact) at a radial position R_{o,2}, wherein R_{i,2}<R_{o,2}; an alternating current (AC) power source electrically connected to one or both of the first electrical coil and the second electrical coil; and an amplifier electrically connected to one or both of the first electrical coil and the second electrical coil. The first electrical coil is generally capable of induction when electrical current flows between the inner and outer nodes of the first coil. Similarly, the second electrical coil is generally capable of induction when electrical current flows between the inner and outer nodes of the second coil. In embodiments, R_{i,1}<R_{o,1}<R_{i,2}<R_{o,2}. The first electrical coil and the second electrical coil can be positioned or otherwise aligned such that they have rotational symmetry with each other, for example by sharing a common center point or axis of rotation in a plane for the coils such that electrical current flows in the same clockwise or counterclockwise direction when the coils are electrically connected in series. The structure of the dual-mode sensor is such that is configured (or adapted) to operate in: (i) an eddy current testing (ECT) mode when the first electrical coil and the second electrical coil are electrically connected to the AC power source to provide magnetic field excitation and magnetic field pickup in the first electrical coil and the second electrical coil, and (ii) a capacitive imaging (CI) mode when the first electrical coil and the second electrical coil are electrically connected to the AC power source such that the first electrical coil and the second electrical coil are charged electrodes in a disk-and-ring capacitor structure (or configuration).

For example, as illustrated in the figures (in particular FIG. 1), Coil 1 and Coil 2 correspond to the first electrical coil and the second electrical coil, respectively. Nodes or Terminals 1 and 2 correspond to the inner node (R_{i,1}) and outer node (R_{o,1}) of the first electrical coil, respectively. Nodes or Terminals 3 and 4 correspond to the inner node (R_{i,2}) and outer node (R_{o,2}) of the second electrical coil, respectively. The radii of the different coils can be altered to obtain balance between the size of the overall coil and the depth of penetration of the EM field. The space between the coils is preferably kept small to minimize the overall size of the sensor. The two different ECT and CI detection/sensing modes can be effected or alternated by any suitable sets of electrical/electronic switches providing electrical connections (and/or electrically isolated states) between the AC power source, the amplifier, and the various nodes of the first and second electrical coils. Specific examples of switches and corresponding circuit structures for different ECT and CI sensing modes are provided below.

Various refinements of the disclosed sensor and sensor array are possible.

In a refinement, the AC power source is electrically connected to the inner node of the first electrical coil (e.g., at R_{i,1}) and to the outer node of the second electrical coil (e.g., at R_{o,2}) (e.g., at opposing terminals of the power source); the amplifier is electrically connected to the inner node of the first electrical coil (e.g., at R_{i,1}) and to the outer node of the second electrical coil (e.g., at R_{o,2}) (e.g., at opposing terminals of the amplifier); and the sensor further comprises a switch (e.g., first switch, such an SPST switch) electrically coupled to the outer node of the first electrical coil (e.g., at R_{o,1}) and to the inner node of the second electrical coil (e.g., at R_{i,2}) such that: in a closed configuration (or position) of the switch, the sensor is configured to operate in the ECT mode (e.g., first and second coils connected in series in an impedance configuration as illustrated in FIG. 3), and in an open configuration (or position) of the switch, the sensor is configured to operate in the CI mode (e.g., first and second coils are not connected in series and instead serve as separate electrodes in a disk-and-ring capacitor configuration as illustrated in FIG. 4). Although the amplifiers in the figures are illustrated with +/− terminals, the different illustrated circuitry can be connected to the amplifier at either terminal.

In a refinement, the AC power source is electrically connected to the inner node of the first electrical coil (e.g., at R_{i,1}) and to the outer node of the first electrical coil (e.g., at R_{o,1}); the amplifier is electrically connected to the inner node of the first electrical coil (e.g., at R_{i,1}) and to the outer node of the first electrical coil (e.g., at R_{o,1}); and the sensor is configured to operate in a higher resolution ECT mode as compared to the ECT mode when the first electrical coil and the second electrical coil are electrically connected to the AC power source (e.g., higher spatial resolution/lower penetration depth embodiment illustrated in FIG. 5 when the second electrical coil is bypassed/electrically isolated). This embodiment can be incorporated into the base dual-mode configuration of FIGS. 3 and 4 by incorporating additional switches (e.g., second switches relative to the first switch between nodes/terminals 2 and 3) such that the AC power supply and amplifier can be toggled between states in which they are electrically connected to node/terminal 2 (as in FIG. 5) or to node/terminal 4 (as in FIGS. 3/4). In such a case, the first switch between terminals 2/3 can be open to completely ignore/bypass coil L2 illustrated in FIG. 3.

This approach can be extended in the other direction to add a third concentric coil of even larger radius such that all three coils could be connected in series for a comparatively higher penetration depth, but lower resolution ECT mode as compared to the base ECT mode. Similarly, a fourth concentric coil of even larger radius to not only provide a further option for ECT operation (e.g., yet further penetration depth but with lower resolution), but also an alternative CI mode: For example, the inner two rings (e.g., first and second electrical coils) connected in series can form a collective first CI electrode, and the outer two rings (e.g., third and fourth electrical coils) connected in series can form a collective second CI electrode. More generally, this approach can be extended to an arbitrary number of concentric coils such that the apparatus can control the size/sensitivity (e.g., penetration depth vs. resolution) of the sensor in finer increments, for example where the sensor also includes the switching circuitry to custom-select the radii of the collective inner and outer electrodes.

For example, in a refinement, the sensor further comprises a third electrical coil around and concentric with the second electric coil, the third electrical coil defining (or having) (i) an inner node (or terminal/point of electrical contact) at a radial position R_{i,3} and (ii) an outer node (or terminal/point of electrical contact) at a radial position R_{o,3}, wherein R_{i,3}<R_{o,3} (e.g., capable of induction when electrical current flows between the inner and outer nodes of the third coil); and a fourth electrical coil around and concentric with the third electric coil, the fourth electrical coil defining (or having) (i) an inner node (or terminal/point of electrical contact) at a radial position R_{i,4} and (ii) an outer node (or terminal/point of electrical contact) at a radial position R_{o,4}, wherein R_{i,4}<R_{o,4} (e.g., capable of induction when electrical current flows between the inner and outer nodes of the fourth coil; in general R_{i,1}<R_{o,1}<R_{i,2}<R_{o,2}<R_{i,3}<R_{o,3}<R_{i,4}<R_{o,4}). As described above, the AC power source and the amplifier can be electrically connected to one or both of the third electrical coil and the fourth electrical coil. In this refinement, the dual-mode sensor is further configured (or adapted) to operate in: (i) an eddy current testing (ECT) mode when the first, second, third, and fourth electrical coils are electrically connected to the AC power source to provide magnetic field excitation and magnetic field pickup in the first, second, third, and fourth electrical coils, and (ii) a capacitive imaging (CI) mode when the first, second, third, and fourth electrical coils are electrically connected to the AC power source such that the first and second electrical coils, and the third and fourth electrical coils are charged electrodes, respectively, in a disk-and-ring capacitor structure (or configuration), such as where the first and second electrical coils collectively form the disk electrode, and the third and fourth electrical coils collectively form the ring electrode.

In a refinement, the AC power source is electrically connected in parallel to the inner nodes of the first electrical coil (e.g., at R_{i,1}) and the second electrical coil (e.g., at R_{i,2}), and in parallel to the outer nodes of the first electrical coil (e.g., at R_{o,1}) and the second electrical coil (e.g., at R_{o,2}); the amplifier is electrically connected to the inner node of the first electrical coil (e.g., at R_{i,1}) and to the inner node of the second electrical coil (e.g., at R_{i,2}); and the sensor is configured to operate in a differential ECT mode (e.g., as illustrated in FIG. 6). This can be incorporated into the base dual-mode configuration of FIGS. 3 and 4 by incorporating additional switches (e.g., second switches relative to the first switch between nodes/terminals 2 and 3) such that the AC power supply can be toggled between states in which it is electrically connected to nodes/terminals 1/3 and 2/4 in parallel (as in FIG. 6) or to nodes/terminals 1 and 4 (as in FIGS. 3 and 4), and the amplifier can be toggled between states in which it is electrically connected to node/terminal 3 (as in FIG. 6) or to node/terminal 4 (as in FIGS. 3 and 4). The first switch between terminals 2/3 would be open in the differential ECT mode of FIG. 6.

In a refinement, the AC power source is electrically connected to the inner node of the first electrical coil (e.g., at R_{i,1}) and to the outer node of the first electrical coil (e.g., at R_{o,1}); the amplifier is electrically connected to the inner node of the second electrical coil (e.g., at R_{i,2}) and to the outer node of the second electrical coil (e.g., at R_{o,2}); and the sensor is configured to operate in a reflection ECT mode (e.g., as illustrated in FIG. 7). In an alternative or additional refinement, the AC power source is electrically connected to the inner node of the second electrical coil (e.g., at R_{i,2}) and to the outer node of the second electrical coil (e.g., at R_{o,2}); the amplifier is electrically connected to the inner node of the first electrical coil (e.g., at R_{i,1}) and to the outer node of the first electrical coil (e.g., at R_{o,1}); and the sensor is configured to operate in a reflection ECT mode (e.g., as the non-illustrated complement to FIG. 7). These two embodiments can be incorporated into the base dual-mode configuration of FIGS. 3 and 4 by incorporating additional switches (e.g., second switches relative to the first switch between nodes/terminals 2 and 3) such that the AC power supply can be toggled between states in which it is electrically connected to node/terminal 2 (as in FIG. 7) or to node/terminal 4 (as in FIGS. 3 and 4), and the amplifier can be toggled between states in which it is electrically connected to node/terminal 3 (as in FIG. 7) or to node/terminal 1 (as in FIGS. 3 and 4). The first switch between terminals 2/3 would be open in the reflection ECT mode of FIG. 7.

In a refinement, the sensor comprises a (flexible) printed circuit board (PCB) substrate with the first electric coil and the second electric coil on a surface of the PCB substrate. In other embodiments, the sensor or components thereof can be formed by a three-dimensional (3D) printing or other additive manufacturing process. Furthermore, switches can be placed on the top layer and the coils can be on the bottom. The coils can be multi-layer allowing them to be stacked up per layer to get more windings, thereby providing a stronger EM field.

In a refinement, the amplifier is a differential voltage amplifier.

In another aspect, the dual-mode sensor can be in the form of a dual-mode sensor array comprising a plurality of concentrically aligned first and second electrical coils electrically connected with one or more AC power sources and one or more amplifiers as described above for the various scanning modes of the dual-mode sensor.

In another aspect, the disclosure relates to a method for non-destructive evaluation of a specimen, the method comprising: performing a non-destructive evaluation of a specimen by operating the dual-mode sensor of any of the variously disclosed embodiments, refinements, etc. in at least one of (i) the ECT mode to obtain ECT measurements of the specimen, and (ii) the CI mode to obtain CI measurements of the specimen (e.g., a non-contact inspection); and determining from the ECT measurements and/or the CI measurements whether one or more internal defects are present in the specimen (e.g., defects not otherwise observable from the exterior of the specimen).

Various refinements of the disclosed method for non-destructive evaluation are possible.

In a refinement, the method comprises obtaining both the ECT measurements and the CI measurements for the specimen.

In a refinement, the specimen comprises a composite material. For example, the specimen can include a (continuous) matrix phase or material, and a (distributed or discrete) filler or reinforcement phase or material. For example, the matrix can include any suitable polymeric material, such as a thermoplastic or thermoset polymer. The filler or reinforcement can include a fiber reinforcement or other fillers such as a nano-scale or micro-scale reinforcement (e.g., having a characteristic dimension on the nanometer scale or micrometer scale, respectively). In some embodiments, the composite can include a multilayer (e.g., laminate) structure, and the fibers or other reinforcements in each layer can be the same or different relative to adjacent layers. In some embodiments, the reinforcement materials can include coated, electrically conductive material, such as a metal coated with rubber, plastic, paint, or any dielectric material more generally.

In a further refinement, the fiber-reinforced polymer composite material comprises at least one of continuous fibers and chopped fibers selected from the group consisting of carbon fibers, glass fibers, aromatic polyamide (or aramid) fibers, lignocellulosic fibers (e.g., plant-based or natural fibers such as lignin-, hemicellulose, and/or cellulose-based fibers), metal fibers (e.g., copper, steel), and combinations thereof.

In a further refinement, the fiber-reinforced polymer composite material comprises at least one of an epoxy material (e.g., cured/crosslinked thermoset epoxy resin), a vinyl ester material (e.g., cured/crosslinked thermoset epoxy resin esterified with a (meth)acrylic acid), a polyester (e.g., polyethylene terephthalate (PET), polylactones such polycaprolactone (PCL)), a polyamide (or nylon, such as nylon-6,6, nylon-6, etc.), a polyolefin (e.g., polyethylene, polypropylene), a polyaryletherketone (PAEK; such as polyether ether ketone (PEEK), polyetherketoneketone (PEKK)), a polyphenylene sulfide (PPS), and combinations thereof.

In a further refinement, the fiber-reinforced polymer composite material comprises a multi-layered composite (e.g., multiple layers of the same or different matrix and/or filler/reinforcement applied in succession to build an aggregate laminate structure for the overall composite).

In a refinement, the defects are selected from the group consisting of interlayer delamination, irregular fiber distribution, fiber breakage, (internal) matrix damage or irregularities, void volumes (e.g., air or other gas pockets), missing fibers, one or more missing plies (or layers), ply (or layer) folds, fiber agglomeration (e.g., in chopped or short fiber composites), resin-rich areas (e.g., maldistribution of matrix material), improper curing (e.g., cross-linking), presence of contaminants (e.g., foreign object, debris, or other non-intended material inclusion), matrix-cracks and combinations thereof. The foregoing defects can apply to composite materials more generally, for example where the various fiber-based defects can apply analogously to other reinforcement or filler phase materials (e.g., irregular reinforcement distribution, reinforcement agglomeration, reinforcement breakage, etc.).

In a refinement, the specimen comprises a coated metallic substrate. For example, the substrate can include a metallic plate, wire, tube, etc. with a coating such as a dielectric insulator, and the method can be used to detect defects in the metal substrate.

In a refinement, the specimen comprises an article having at least two different segments joined at an interface. This can represent two (same or different) substrates such as metals or other materials connected by a joint at their interface, for example when the method is used to detect defects in the joint or interface. When the top adherend of a specimen (i.e., substrate or material closest to the sensor), is a metal, the metal material generally obscures observation of the joint interface. In such cases, ECT can be used to study the defects in the metal and not in the interface. In cases where the top adherend is not a metal or otherwise electrically conductive, then the sensor can be operated in CI mode to evaluate possible adhesive bondline defects.

In a refinement, the method further comprises: forming the specimen; and then performing the method for non-destructive evaluation on the specimen to determine whether one or more internal defects are present in the specimen. This can represent an integrated process include the NDE process as a quality control or other check performed after manufacturing an FRP composite material or other specimen. Such an evaluation process can be used to detect more than one type of defect (irrespective of the type of defect).

Additional features of the disclosure may become apparent to those skilled in the art from a review of the following detailed description, taken in conjunction with the drawings, examples, and appended claims.

### BRIEF DESCRIPTION OF THE DRAWINGS

For a more complete understanding of the disclosure, reference should be made to the following detailed description and accompanying drawings wherein:

FIG. 1 illustrates first and second electrical coils of a dual-mode sensor according to the disclosure.

FIG. 2 illustrates an array of first/second electrical coils in a dual-mode sensor array of according to the disclosure.

FIG. 3 illustrates an electrical circuit of the dual-mode sensor for absolute ECT measurements.

FIG. 4 illustrates an electrical circuit of the dual-mode sensor for absolute CI measurements.

FIG. 5 illustrates an electrical circuit of the dual-mode sensor for absolute ECT measurements in high resolution mode.

FIG. 6 illustrates an electrical circuit of the dual-mode sensor for differential ECT measurements.

FIG. 7 illustrates an electrical circuit of the dual-mode sensor for reflection (transmit-receive) ECT measurements.

FIG. 8 illustrates a method of non-destructive evaluation of a specimen using the disclosed dual-mode sensor.

FIG. 9 illustrates (A) the geometry and locations of the defects in Sample 1, (B) the CI scan result for Sample 1, and (C) the ECT scan result for Sample 1.

FIG. 10 illustrates (A) the geometry and locations of the defects in Sample 2, and (B) the CI scan result for Sample 2.

FIG. 11 illustrates (A) the geometry and locations of the defects in Sample 3, and (B) the CI scan result for Sample 3.

While the disclosed compositions and methods are susceptible of embodiments in various forms, specific embodiments of the disclosure are illustrated (and will hereafter be described) with the understanding that the disclosure is intended to be illustrative, and is not intended to limit the claims to the specific embodiments described and illustrated herein.

### DETAILED DESCRIPTION

The disclosure relates to a dual-mode sensor and sensor array for eddy current testing and capacitive imaging, for example for use in non-destructive evaluation (NDE) of a specimen to detect potential internal defects within the specimen. The sensor includes first and second concentrically aligned electrical coils in electrical connection with an AC power source and an amplifier, and the electrical coils are capable of induction when electrical current flows between the inner and outer nodes of a given coil. The concentric structure of the electrical coils allows the dual-mode sensor to operate in either an eddy current testing (ECT) mode or a capacitive imaging (CI) mode. In the ECT mode, the first electrical coil and the second electrical coil are electrically connected to the AC power source to provide magnetic field excitation and magnetic field pickup in the first electrical coil and the second electrical coil. In the CI mode, the first electrical coil and the second electrical coil are electrically connected to the AC power source such that the first electrical coil and the second electrical coil are charged electrodes in a disk-and-ring capacitor configuration. The sensor or sensor array can be used for nondestructive evaluation of fiber reinforced polymer (FRP) composites and advanced composite structures, including but not limited to multi-layered carbon, glass, and aramid FRP made of continuous or chopped fibers. NDE is performed using the dual-mode eddy current and capacitive array probe, for example having sensors with concentric windings fabricated on a multi-layered flexible printed circuit board (FPCB).

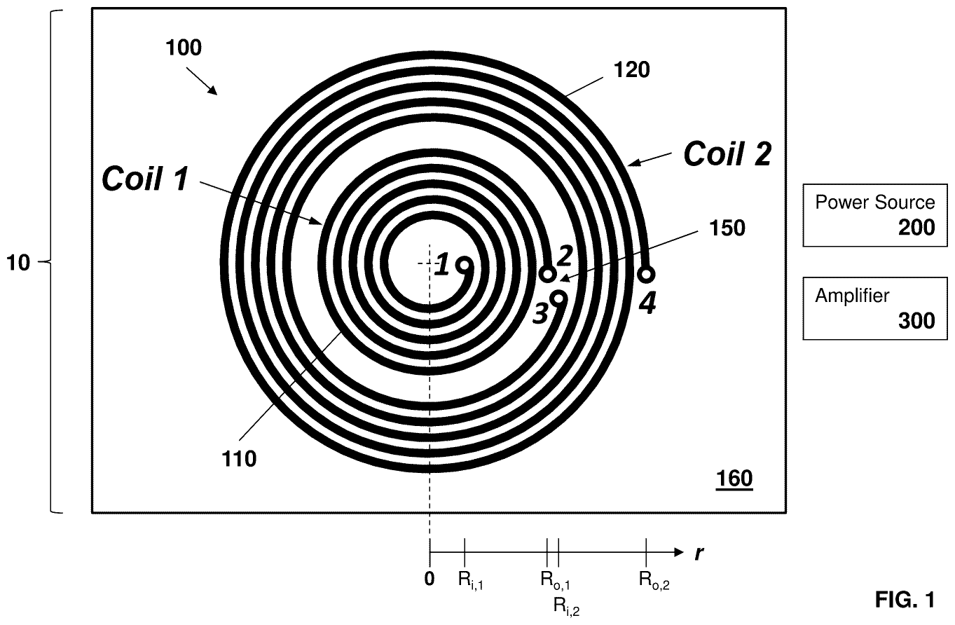

FIG. 1 illustrates a dual-mode sensor 10 according to the disclosure. The dual (ECT and CI) concentrical sensor 10 and arrays thereof may be used for flaw detection in FRP composites. The sensor 10, having the advantage of rotational symmetry, includes a plurality of concentric electrical coils 100, including a first electrical coil 110 (or central pancake coil; “Coil 1”) and a second electrical coil 120 (or outer ring coil, “Coil 2”), which are concentrically aligned with each other. The first electrical coil 110 has an inner node 1 at radial position R_{i,1} and an outer node 2 at radial position R_{o,1}, where R_{i,1}<R_{o,1}. Similarly, the second electrical 120 coil has an inner node 3 at radial position R_{i,2} and an outer node 4 at radial position R_{o,2}, where R_{i,2}<R_{o,2}. The different radii are selected such that R_{i,1}<R_{o,1}<R_{i,2}<R_{o,2}. Both coils 100 can be printed on a multi-layered flexible printed circuit board (FPCB) or other substrate 160 such that the windings in each layer provide the same direction of current flow (e.g. clockwise or counterclockwise).

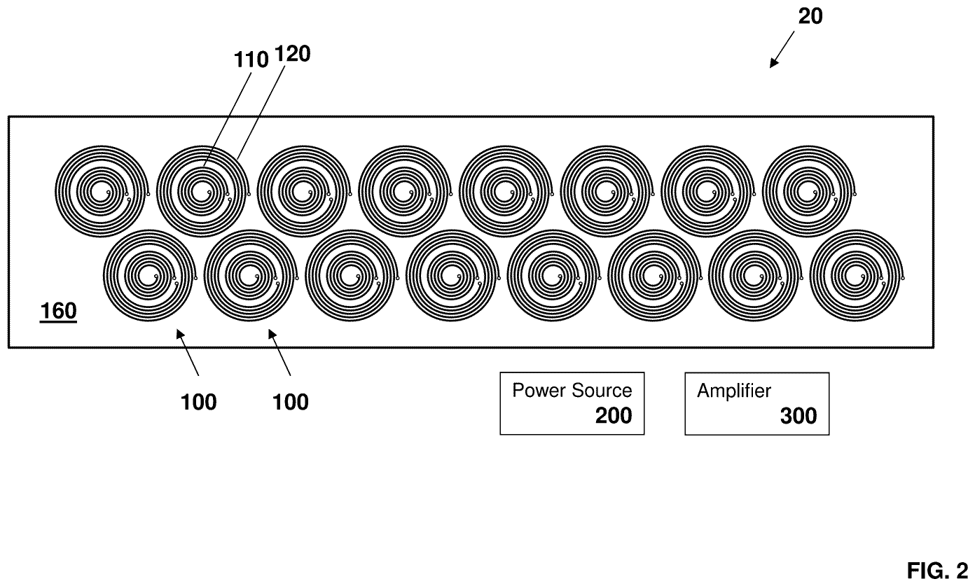

The sensor 10 further includes an alternating current (AC) power source 200 and an amplifier 300, both of which can be electrically connected to one or both of the first electrical coil 110 and the second electrical coil 120. Specific electrical connections between the power source 200, the amplifier 300, and the coils 110, 120 are selectable/adjustable, and they determine the sensing mode in which the sensor 10 operates. ECT and CI inspection modalities are realized by establishing proper electrical connections between the coils 100, the AC source 200, and the receiving amplifier 300 through contact switching or multiplexing. If the sensor 10 is configured for ECT, the coils 100 are used as means for magnetic field excitation and magnetic field pick up. In CI mode, the central pancake coil 110 and the outer ring coil 120 serve as charged electrodes of the disk-and-ring capacitor, which generates the electric field for probing the test sample. ECT and CI measurements are time-domain sequenced, hence eliminating the need for installing two separate sensor types in one probe. A dual-mode sensor array 20 probe can be formed from staggered linear arrays of individual dual-mode sensors 10, or arrays of pairs of first coils 110 and second coils 120 electrically coupled to the power source 200 and the amplifier 300, as shown in FIG. 2. Each individual pair of first coils 110 and second coils 120 can be independently configured to switch between and/or operate in any ECT or CI mode, such as absolute ECT mode, high-resolution ECT mode, differential ECT mode, reflection ECT mode, absolute CI mode, etc. For example, some coil pairs 100 in the array 20 can be configured to operate in absolute ECT mode, some in differential ECT mode, and some in absolute CI mode such that a single scan of sample with the array 20 can provide multiple types of ECT and/or CI results.

ECT mode of the hybrid sensor 10 furnishes information about local changes of the electric conductivity of a given FRP specimen. Hence, this mode is used mainly for inspecting electrically conductive CFRP for fiber damage and/or fiber irregularities. On the other hand, CI mode of the hybrid sensor 10 provides sensitivity to local changes of the dielectric properties of the FRP specimen. The dual-mode sensor 10 configured as the disk-and-ring capacitor supports NDE of dielectric FRP and CFRP with weak electrical conductivity in the transverse direction. CI mode is mostly sensitive to matrix damage, fiber/matrix irregularities, and/or interlaminar delaminations.

Combining ECT and CI techniques in a single dual-mode sensor 10 provides synergy to detect different types of flaws, for example fiber breakage and interlaminar delaminations in CFRP, that would not be otherwise both detectable by only one technique. The applications of the dual-mode sensor are not limited to FRP composites. Others may include the inspection of metallic structures such as plates, wires or pipes coated with dielectric insulators, and NDE of dissimilar material joints, to name a few.

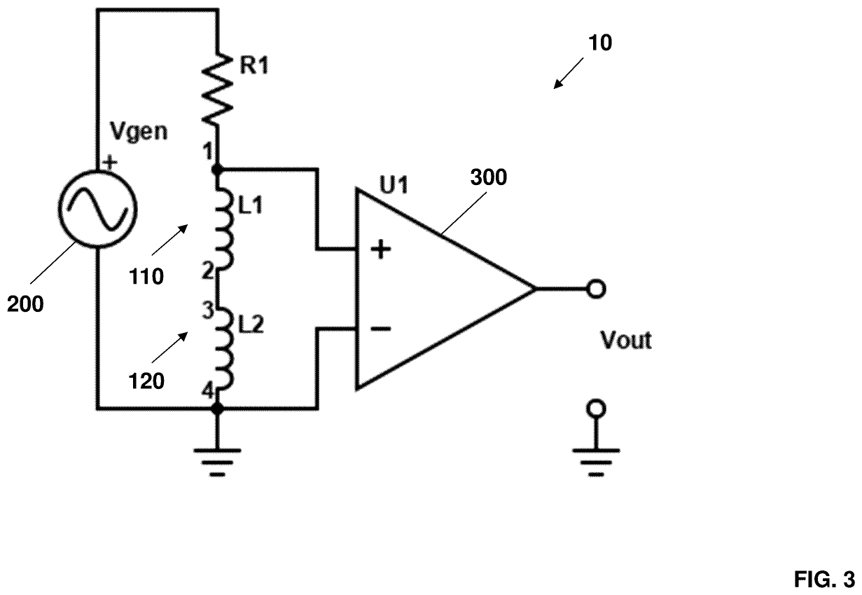

FIG. 3 illustrates an electrical circuit for configuring the dual-mode sensor 10 for absolute ECT measurements using the first electrical coil 110 and the second electrical coil 120 connected in series. Specifically, the sensor 10 is adapted or configured to operate in ECT mode when the first electrical coil 110 and the second electrical coil 120 are electrically connected to the AC power source 200 to provide magnetic field excitation and magnetic field pickup in the first electrical coil 110 and the second electrical coil 120. Dual modality sensing can be accomplished by including a switch 150 (e.g., a single pole single throw (SPST) switch) between the outer node 2 (coil 110) and the inner node 3 (coil 120) of the sensor 10 (FIG. 1). When the coils 100 are connected to the AC generator 200 and to the receiving amplifier 300 as illustrated in FIG. 3, and the switch 160 is closed, the ECT inspection in the absolute (a.k.a. impedance) configuration will be performed. Specifically, the AC power source 200 is electrically connected to the inner node 1 of the first electrical coil 110 and to the outer node 4 of the second electrical coil 120, the amplifier 300 is electrically connected to the inner node 1 of the first electrical coil 110 and to the outer node 4 of the second electrical coil 120, and the switch 150 is closed (i.e., electrically connecting the outer node 2 and the inner node 3). In this configuration, the ECT sensor 10 includes the first electrical coil 110 and the second electrical coil 120 connected in series.

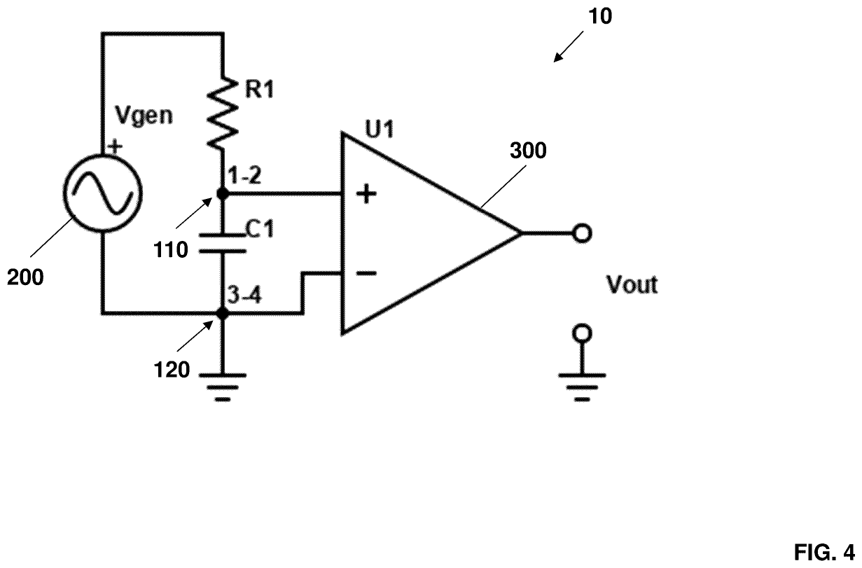

FIG. 4 illustrates an electrical circuit for configuring the dual-mode sensor 10 for absolute CI measurements. Specifically, the AC power source 200 is electrically connected to the inner node 1 of the first electrical coil 110 and to the outer node 4 of the second electrical coil 120, the amplifier 300 is electrically connected to the inner node 1 of the first electrical coil 110 and to the outer node 4 of the second electrical coil 120, and the switch 150 is open (i.e., electrically disconnecting the outer node 2 from the inner node 3). Compared to the ECT mode in FIG. 3, the CI in its absolute configuration is performed simply by flipping the switch 150 to the open position. In this way, the first electrical coil 110 and the second electrical coil 120 will serve as separate electrodes of the disk-and-ring capacitor as shown in FIG. 4. The dual-mode sensor 10 will be sensitive to flaws of all in-plane orientations since the excited magnetic field and electric field will possess rotational symmetry about the center of the sensor. Finite element simulations (not shown) comparing the electric fields generated in the dielectric using the dual-mode sensor 10 in CI mode a conventional annular capacitor with solid electrodes show that the produced fields are virtually identical, meaning that both sensors provide equivalent CI results.

In order to keep the dual-mode sensor 10 practical and compatible with commercial data acquisition systems for array ECT, the same differential voltage amplifier 300 as in FIG. 3 can be used for signal pick up from the terminals of the capacitive sensor. Generally, capacitive probes benefit from using charge amplifiers, since the output voltage does not depend on the length and capacitance of the cable attached to the probe. However, in typical NDE systems for ECT, array probes are fabricated with permanently attached cables, which makes the issue of using a voltage amplifier less important.

The dual-mode sensor 10 can be used in additional configurations beyond those illustrated in FIGS. 3-4. These additional or advanced configurations can be implemented with multiplexing of sensor terminals and/or inclusion of electrical switches, thus providing the ability to select between any of the disclosed electrical circuits/electrical connections between the power supply 200, the amplifier 300, and the various nodes of the electrical coils 100 such that the sensor 10 can be operated in any of the various CI and/or ECT sensing modes.

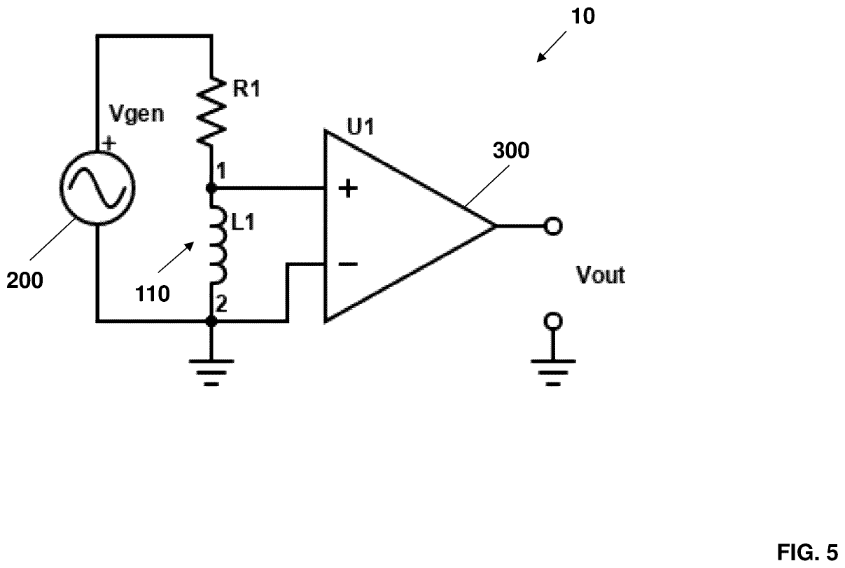

In some embodiments, the sensor 10 can be operated to drive only the first electrical coil 110 for ECT measurements in the absolute mode instead of coils 110, 120 in series. For example, if the AC power source 200 is electrically connected to the inner node 1 of the first electrical coil 110 and to the outer node 2 of the first electrical coil 110, and the amplifier 300 is electrically connected to the inner node 1 of the first electrical coil 110 and to the outer node 2 of the first electrical coil 110, then the sensor 10 can be configured to operate in a relatively higher resolution ECT mode as compared to the two-coil system described above. If the second electrical coil 120 ring is disconnected from the circuit as illustrated in FIG. 5, the magnetic field excited by the central the first electrical coil 110 will be more compact, thereby improving the spatial resolution of ECT measurements. However, this will come at the cost of reduced penetration depth of the field into the test specimen. Finite element simulations (not shown) comparing the electric current density generated in an aluminum substrate showed that the induced eddy current was stronger for two coils driven in series; hence this configuration may be used for NDE of thick CFRP or sandwich CFRP with conductive honeycomb cores.

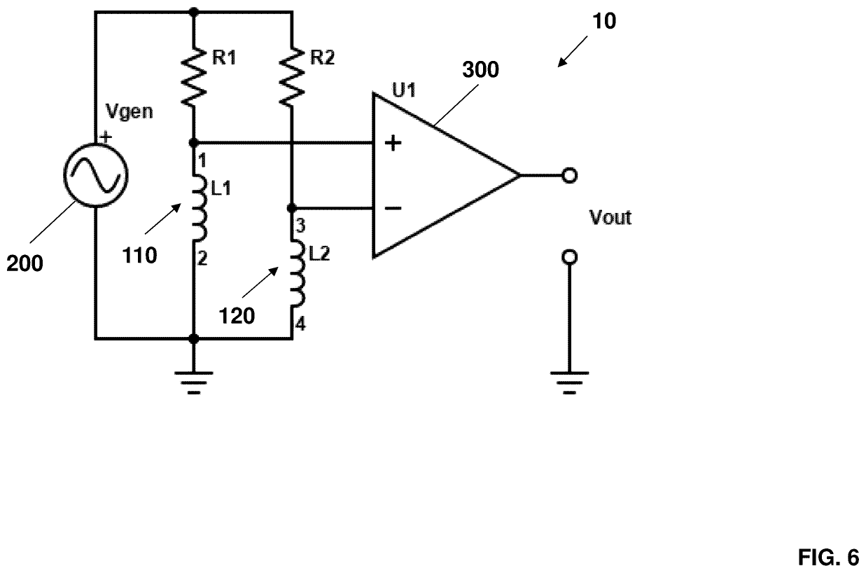

In some embodiments, the sensor 10 can be operated to acquire differential ECT measurements using the coils 100 to reduce the sensitivity of measured ECT signals to lift-off variations. FIG. 6 illustrates an electrical circuit showing the first electrical coil 110 and the second electrical coil 120 connected in a Wheatstone bridge. Specifically, the AC power source 200 is electrically connected in parallel to the inner nodes 1, 3, of the first electrical coil 110 and the second electrical coil 120, and in parallel to the outer nodes 2, 4 of the first electrical coil 110 and the second electrical coil 120. As also shown, the amplifier 300 is electrically connected to the inner node 1 of the first electrical coil 110 and to the inner node 3 of the second electrical coil 120. The bridge need not be perfectly balanced, since the first and second coils 110, 120 have different geometries. However, an acceptable level of balancing for practical use can be achieved by adjusting the coil geometries at the design stage such that their respective impedances will be reasonably similar in a given frequency range.

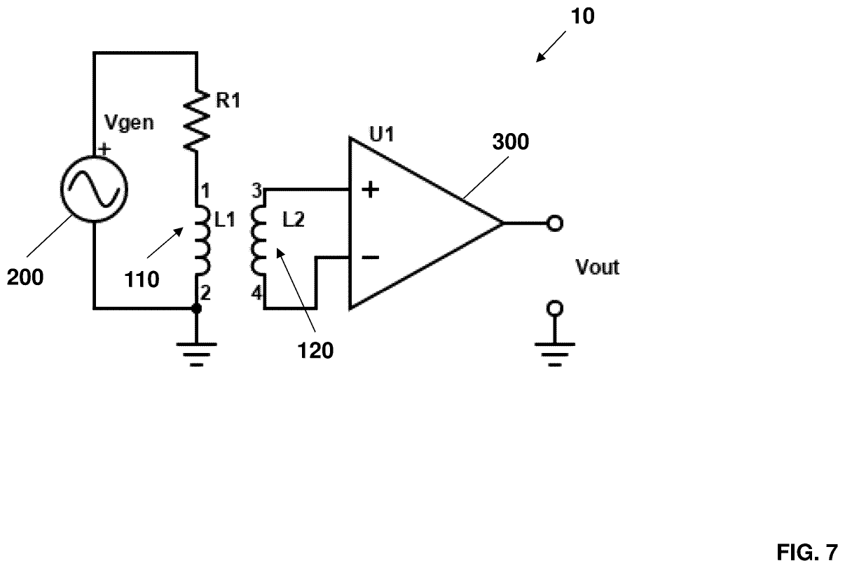

In some embodiments, the sensor 10 can be operated to acquire reflection ECT measurements using the first electrical coil 110 as a transmitter and the second electrical coil 120 as a receiver, or vice versa. A corresponding electric circuit for configuring the dual-mode sensor 10 in reflection mode is shown in FIG. 7. Specifically, the AC power source 200 is electrically connected to the inner node 1 of the first electrical coil 110 and to the outer node 2 of the first electrical coil 110, and the amplifier 300 is electrically connected to the inner node 3 of the second electrical coil 120 and to the outer node 4 of the second electrical coil 120.

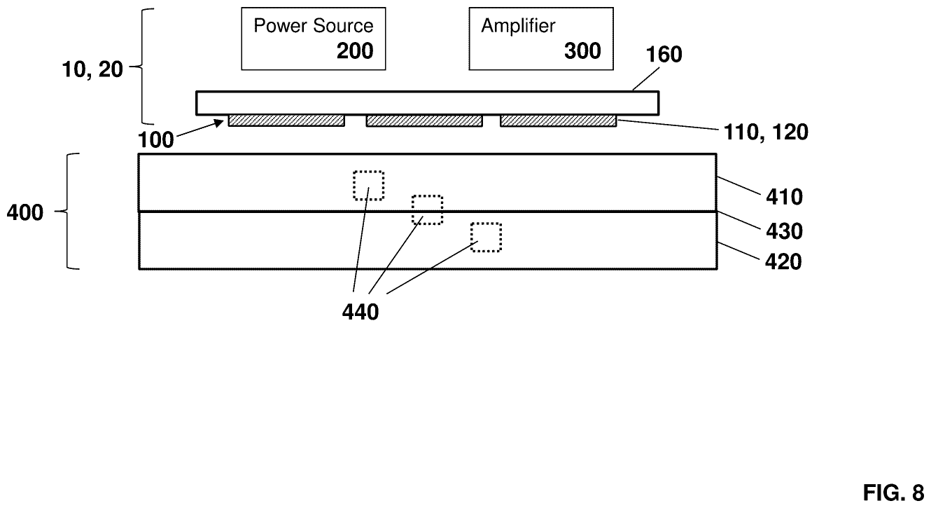

FIG. 8 illustrates a method of using the sensor 10 or sensor array 20 for non-destructive evaluation of a specimen 400. The sensor 10 or sensor array 20 can be in any of the variously disclosed embodiments, and it is illustrated FIG. 8 as an array 20 having three coil pairs 100 of first and second coils 110, 120 that are electrically connected to a power source 200 and/or an amplifier, for example with suitable switching and/or multiplexing apparatus (not shown) to adjust individual coil pairs 100 to the desired electrical connections/electrical circuits operate in any of the disclosed ECT modes to obtain ECT measurements of the specimen 400, and/or operate in any of the disclosed CI modes to obtain CI measurements of the specimen 400. Different coil pairs 100 can be configured to obtain different measurements in a single scan (e.g., some coil pairs 100 can obtain ECT measurements and other coil pairs 100 can obtain CI measurements). The ECT measurements and/or the CI measurements can be used to determine one or more internal defects 440 are present in the specimen 400.

FIG. 8 also illustrates a specimen 400 having two joined or otherwise adjacent layers or structures, including a first layer 410 and a second layer 420 joined or otherwise adjacent to each other at an interface 430. The specimen 400 can be a multi-layered composite, for example where the first layer 410 is a first fiber-reinforced polymer composite material and the second layer 420 is a second fiber-reinforced polymer composite material (e.g., same or different types of FRPs). In other cases (not shown), the specimen 400 can be a single-layer composite or other material. While the specimen 400 is illustrated as a multi-layered composite, the specimen 400 can include other types of adjacent layers or structures, for example a metal substrate 420 having a coating 410 (e.g., dielectric insulator) thereon in a coated metal specimen 400, a first segment 410 joined to a second segment 420 in a joined article 400, etc.

As illustrated in FIG. 8, defects 440 can occur within (or entirely within) the first layer 410, within (or entirely within) the second layer 420, and/or at the interface 430 between the layers 410, 420. Examples of possible defects that can be detected by one or both of the ECT and CI measurements include one or more of interlayer delamination, irregular fiber distribution, fiber breakage, matrix damage or irregularities, void volumes, missing fibers, one or more missing plies, ply folds, fiber agglomeration, resin-rich areas, improper curing, presence of contaminants, matrix-cracks.

### Examples

The examples illustrate the disclosed apparatus and methods, but are not intended to limit the scope of any claims thereto. In particular, the examples illustrate the fabrication and testing of a dual mode sensor according to the disclosure for non-destructive evaluation (NDE) of test composite samples.

A dual-mode concentrical sensor for flaw detection in fiber-reinforced polymer (FRP) composites using eddy current testing (ECT) and capacitive imaging (CI) was fabricated. Combining ECT and CI techniques provides synergy to detect damage in both electrically conductive and insulative FRP materials. The sensor, featuring rotational symmetry, includes a central pancake coil and an outer ring coil, both printed on a multi-layered printed circuit board (PCB). When configured for ECT, the coils serve as a means for magnetic field excitation and pickup, while in CI mode, the central pancake coil and the outer ring coil function as charged electrodes of the disk-and-ring capacitor. A dual-mode array probe is created using staggered linear arrays of individual sensors. Experimental validation demonstrates the capability to detect volumetric flaws, fiber breakage, and interlaminar delaminations in carbon FRP.

Sensor Design: The sensor, having the advantage of rotational symmetry, consists of an inner pancake coil (Coil 1) and an outer ring coil (Coil 2) as shown in FIG. 1. Both coils are printed on a multi-layered PCB such that the windings in each layer provide the same direction of current flow (e.g. clockwise or counterclockwise). If the sensor is configured for ECT, the coils are used as a means for magnetic field excitation and magnetic field pick up as illustrated in FIG. 3. In CI mode, the central pancake coil and the outer ring coil serve as charged electrodes of the disk-and-ring capacitor, which generates the electric field for probing the specimen as shown in FIG. 4. Switching between the inspection modes is accomplished by connecting or disconnecting coil terminals 2 and 3. Signals are measured using the lock-in amplifier.

Sensor and Array Fabrication: A dual-mode sensor array was fabricated on a 2-layer PCB using a plurality of inner/outer ring combinations, in a layout as generally shown in FIG. 2, although the fabricated array had only 9 sensors (i.e., 4 inner/outer ring combinations in a top and 5 inner/outer ring combinations in a bottom row). The radii of the inner and outer coils (s and D/2) were 3 mm and 5 mm, respectively. The gap (g) between the coils was 0.25 mm. The distance between the centers of coils in one row was 14 mm. Each coil was individually interfaced to a micro-coax connector.

Experimental Setup: The dual-mode sensor array underwent experimental validation employing a robotic system including associated computer, controller, data acquisition, and indexable/translatable robot arms with end effectors. The dual-mode probe was attached to the robot's end effector using a 3D printed fixture. Sensors were interfaced to the data acquisition system using micro-coax cables and the Eddy Current Array (ECA) connector. Separate scans were performed for ECT and CI data. Concurrent ECT and CI scans could be implemented using an external multiplexer connected to the data acquisition system and/or with added electronic switches, for example.

The measured ECT and CI signals were passed through an integrated lock-in amplifier. Control over the data acquisition process, scan path planning, and the motion of the robotic arm was executed using a PC and scripts developed in C#. The NDE measurements were successfully synchronized with the robot positions registered by the controller. The robotic arm was programmed to move at a speed of 20 mm/s. To accommodate the 14 mm offset between the sensors in one row and achieve a 1 mm scan resolution, the array initially performed six line-scans along the y-direction, each with a corresponding 1 mm shift in the x-direction. Subsequently, the array underwent a 56 mm shift in the x-direction, and this process was iterated. The lift-off between the probe and the top surface of the test specimen was less than 1 mm.

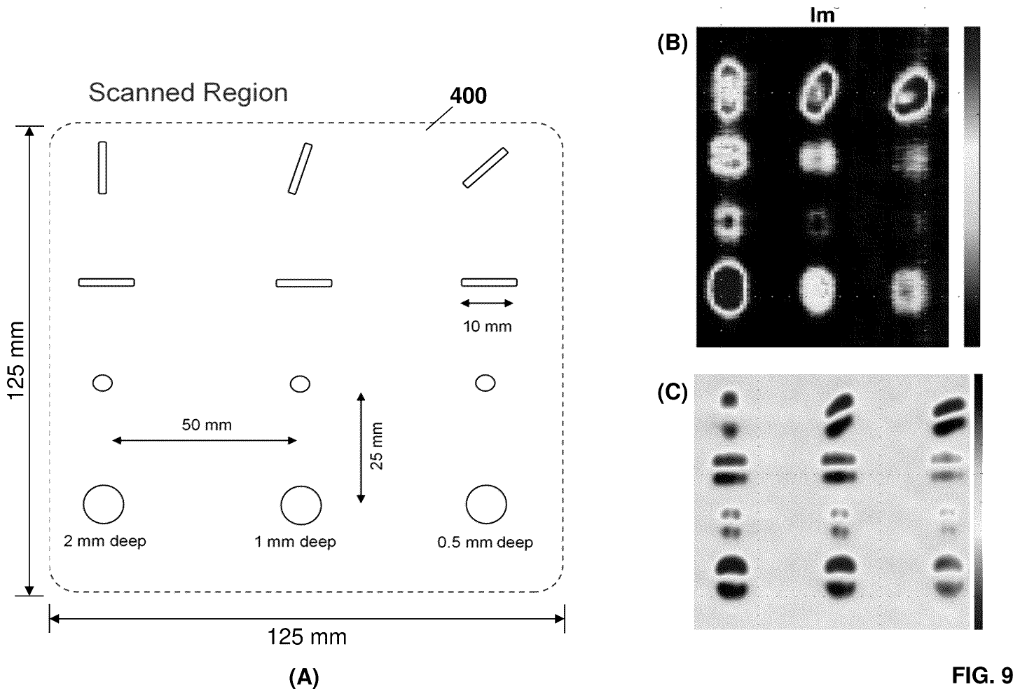

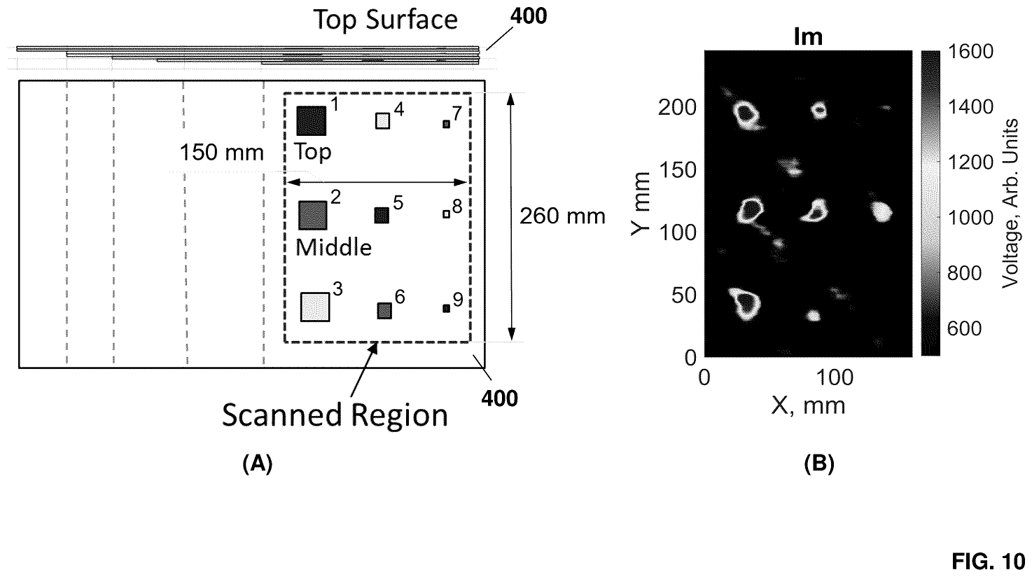

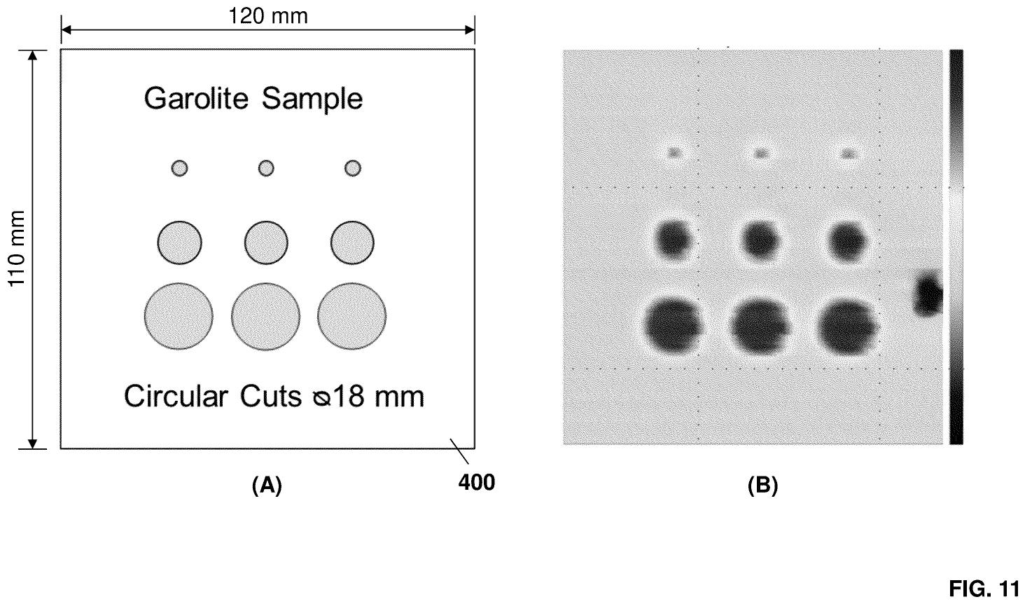

Test Samples: Three FRP test samples were prepared. Samples 1 and 2 were carbon fiber reinforced composites (CFRPs), and Sample 3 was a glass fiber reinforced composite (GFRP). Sample 1 was fabricated using an autoclave and had a thickness of 5 mm. Sample 1 consisted of eight layers of 2×2 twill weave carbon fiber fabric infused with a thermosetting epoxy. To simulate fiber damage, nine defects in the form of notches and holes were precisely milled on the back side of the sample (FIG. 9, panel A). Sample 2 had a stepped profile, and in its thickest region of 7.2 mm it was a classical unidirectional CFRP laminate with [0/90]_{9S} layer stacking sequence. To simulate interlaminar delaminations, polytetrafluoroethylene (TEFLON) inserts in square shapes of varying sizes were strategically embedded after the 4th, 18^{th}, and 32nd plies counting from the top surface (FIG. 10, panel A). The smaller inserts measured 5×5 mm², while the larger ones were 22×22 mm². Sample 3 was a garolite fiberglass laminate, and simulated volumetric defects were formed by making circular cuts of vary diameters up to 18 mm (FIG. 11, panel A).

Results: Sample 1 with fiber damage simulated as cuts underwent scanning in the ECT mode of the array. Given the ECT's lower sensitivity to matrix damage, Sample 2, incorporating flaws in the shape of interlaminar delaminations, was subjected to scanning in the CI mode. Both samples were accessed from the top surface, rendering the defects visually invisible or unobservable from the scanning direction.

FIG. 9 (panel B) shows the C-scan of Sample 1 acquired in the absolute (impedance) coil configuration at f=1.3 MHz. The image was processed in MATLAB, involving the removal of the median value along each line-scan to minimize sensitivity variations among different coils. FIG. 9 (panel C) shows the differential ECT scan of Sample 1 at f=1.5 MHz. The successful detection of flaws, where deeper flaws resulted in higher signals, validated the ECT mode of the array.

FIG. 10 (panel A) depicts the geometry and locations of embedded TEFLON inserts in Sample 2. The ECT scan of Sample 2 at f=2 MHZ (not shown) demonstrated that only the fiber structure of the top layers of the specimen is visible, and defects were not detected. Specifically, the eddy currents predominantly flow along the carbon fibers, and the presence of simulated interlaminar delaminations does not significantly affect the eddy current distribution. The scan of the Sample 2 in CI mode is illustrated in FIG. 10 (panel B). The data were acquired at f=5 MHz. The detection of most TEFLON inserts was successful, except for the two smaller ones. Increasing sensor size can strengthen the electric field and improve flaw detectability. Additionally, the penetration depth of the electric field is constrained by electrical conductivity. The CI sensor can detect the same flaws more effectively in insulating materials. The C-scans in CI mode also showed the probe's sensitivity to internal fiber and/or matrix irregularities within the test specimen. Repeatable indications were noticed in regions devoid of embedded delaminations. It is believed that this observation can be attributed to localized variations in the dielectric properties of the CFRP laminate.

FIG. 11 (panel A) depicts the geometry and locations of the circular cut volume defects in Sample 3. The scan of the Sample 3 in CI mode is illustrated in FIG. 11 (panel B). The data were acquired at f=1 MHz. The detection of the circular cuts was successful.

Because other modifications and changes varied to fit particular operating requirements and environments will be apparent to those skilled in the art, the disclosure is not considered limited to the example chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In case of conflict, the present description, including definitions, will control.

Throughout the specification, where the compositions, processes, kits, or apparatus are described as including components, steps, or materials, it is contemplated that the compositions, processes, or apparatus can also comprise, consist essentially of, or consist of, any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

### LIST OF FIGURE ELEMENTS

10 dual-mode sensor
20 dual-mode sensor array
100 electrical coils
110 first electrical coil (inner node 1, outer node 2)
R_{i,1} inner node radial position of first electrical coil
R_{o,1} outer node radial position of first electrical coil
120 second electrical coil (inner node 3, outer node 4)
R_{i,2} inner node radial position of second electrical coil
R_{o,2} outer node radial position of second electrical coil
150 switch
160 substrate or PCB substrate
200 alternating current (AC) power source
300 amplifier
400 specimen (e.g., composite or multi-layered composite material)
410 first layer or segment
420 second layer or segment
430 interface
440 internal defect(s)

What is claimed is:

1. A dual-mode sensor for eddy current testing and capacitive imaging, the sensor array comprising:
a first electrical coil defining (i) an inner node at a radial position R_{i,1} and (ii) an outer node at a radial position R_{o,1}, wherein R_{i,1}<R_{o,1};
a second electrical coil around and concentric with the first electric coil, the second electrical coil defining (i) an inner node at a radial position R_{i,2} and (ii) an outer node at a radial position R_{o,2}, wherein R_{i,2}<R_{o,2};
an alternating current (AC) power source electrically connected to one or both of the first electrical coil and the second electrical coil; and
an amplifier electrically connected to one or both of the first electrical coil and the second electrical coil;
wherein the dual-mode sensor is configured to operate in:
(i) an eddy current testing (ECT) mode when the first electrical coil and the second electrical coil are electrically connected to the AC power source to provide magnetic field excitation and magnetic field pickup in the first electrical coil and the second electrical coil, and
(ii) a capacitive imaging (CI) mode when the first electrical coil and the second electrical coil are electrically connected to the AC power source such that the first electrical coil and the second electrical coil are charged electrodes in a disk-and-ring capacitor structure.

2. The sensor of claim 1, wherein:
the AC power source is electrically connected to the inner node of the first electrical coil and to the outer node of the second electrical coil;
the amplifier is electrically connected to the inner node of the first electrical coil and to the outer node of the second electrical coil; and
the sensor further comprises a switch electrically coupled to the outer node of the first electrical coil and to the inner node of the second electrical coil such that:
in a closed configuration of the switch, the sensor is configured to operate in the ECT mode, and
in an open configuration of the switch, the sensor is configured to operate in the CI mode.

3. The sensor of claim 1, wherein:
the AC power source is electrically connected to the inner node of the first electrical coil and to the outer node of the first electrical coil;
the amplifier is electrically connected to the inner node of the first electrical coil and to the outer node of the first electrical coil; and
the sensor is configured to operate in a higher resolution ECT mode as compared to the ECT mode when the first electrical coil and the second electrical coil are electrically connected to the AC power source.

4. The sensor of claim 1, further comprising:
a third electrical coil around and concentric with the second electric coil, the third electrical coil defining (i) an inner node at a radial position R_{i,3} and (ii) an outer node at a radial position R_{o,3}, wherein R_{i,3}<R_{o,3}; and
a fourth electrical coil around and concentric with the third electric coil, the fourth electrical coil defining (i) an inner node at a radial position R_{i,4} and (ii) an outer node at a radial position R_{o,4}, wherein R_{i,4}<R_{o,4};
wherein the dual-mode sensor is configured to operate in:
(i) an eddy current testing (ECT) mode when the first, second, third, and fourth electrical coils are electrically connected to the AC power source to provide magnetic field excitation and magnetic field pickup in the first, second, third, and fourth electrical coils, and
(ii) a capacitive imaging (CI) mode when the first, second, third, and fourth electrical coils are electrically connected to the AC power source such that the first and second electrical coils, and the third and fourth electrical coils are charged electrodes, respectively, in a disk-and-ring capacitor structure.

5. The sensor of claim 1, wherein:
the AC power source is electrically connected in parallel to the inner nodes of the first electrical coil and the second electrical coil, and in parallel to the outer nodes of the first electrical coil and the second electrical coil;
the amplifier is electrically connected to the inner node of the first electrical coil and to the inner node of the second electrical coil; and
the sensor is configured to operate in a differential ECT mode.

6. The sensor of claim 1, wherein:
the AC power source is electrically connected to the inner node of the first electrical coil and to the outer node of the first electrical coil;
the amplifier is electrically connected to the inner node of the second electrical coil and to the outer node of the second electrical coil; and
the sensor is configured to operate in a reflection ECT mode.

7. The sensor of claim 1, wherein:
the AC power source is electrically connected to the inner node of the second electrical coil and to the outer node of the second electrical coil;
the amplifier is electrically connected to the inner node of the first electrical coil and to the outer node of the first electrical coil; and
the sensor is configured to operate in a reflection ECT mode.

8. The sensor of claim 1, further comprising:
a printed circuit board (PCB) substrate with the first electric coil and the second electric coil on a surface of the PCB substrate.

9. The sensor of claim 1, wherein the amplifier is a differential voltage amplifier.

10. The sensor of claim 1, comprising:
a plurality of first electrical coils and a plurality of concentrically aligned second electrical coils arranged in an array for dual-mode sensing.

11. A method for non-destructive evaluation of a specimen, the method comprising:
performing a non-destructive evaluation of a specimen by operating the dual-mode sensor of claim 1 in at least one of (i) the ECT mode to obtain ECT measurements of the specimen, and (ii) the CI mode to obtain CI measurements of the specimen; and
determining from the ECT measurements, the CI measurements, or both the ECT measurements and the CI measurements whether one or more internal defects are present in the specimen.

12. The method of claim 11, comprising obtaining both the ECT measurements and the CI measurements for the specimen.

13. The method of claim 11, wherein the specimen comprises a composite material.

14. The method of claim 11, wherein the specimen comprises a fiber-reinforced polymer composite material.

15. The method of claim 14, wherein the fiber-reinforced polymer composite material comprises at least one of continuous fibers and chopped fibers selected from the group consisting of carbon fibers, glass fibers, aromatic polyamide fibers, lignocellulosic fibers, metal fibers, and combinations thereof.

16. The method of claim 14, wherein the fiber-reinforced polymer composite material comprises at least one of an epoxy material, a vinyl ester material, a polyester, a polyamide, a polyolefin, a polyaryletherketone (PAEK), a polyphenylene sulfide (PPS), and combinations thereof.

17. The method of claim 14, wherein the fiber-reinforced polymer composite material comprises a multi-layered composite.

18. The method of claim 14, wherein the defects are selected from the group consisting of interlayer delamination, irregular fiber distribution, fiber breakage, matrix damage or irregularities, void volumes, missing fibers, one or more missing plies, ply folds, fiber agglomeration, resin-rich areas, improper curing, presence of contaminants, matrix-cracks and combinations thereof.

19. The method of claim 11, wherein the specimen comprises a coated metallic substrate.

20. The method of claim 11, wherein the specimen comprises an article having at least two different segments joined at an interface.

21. The method of claim 11, further comprising:
forming the specimen; and then
performing the non-destructive evaluation of the specimen to determine whether one or more internal defects are present in the specimen.
